(19) United States
(12) Patent Application Publication
(10) Pub. No.: US 2005/0177407 A1
(43) Pub. Date: Aug. 11, 2005

(54) Method and computer system for schedule trading

(76) Inventor: Meghan M. Barni, Mahopac, NY (US)

Correspondence Address: David H. Judson;Locke, Liddell & Sapp, LLP, Suite 2200, 2200 Ross Avenue, Dallas, TX, 75201, US

(21) Appl. No.: 10/777,052

(22) Filed: Feb. 9, 2004

(51) Int. Cl. G06F 17/60

(52) U.S. Cl. 705/8

(57) ABSTRACT

The present invention provides a method and apparatus for trading employee schedules online. One or more rules for determining which schedules may be traded are defined. One or more employee schedules are posted for trade. For each posted schedule, the requirements of the schedule that the employee would like in exchange are also posted. Two schedules are matched for trading based on (a) their respective requirements for the schedule required in return, and (b) the rules that were previously defined. If two schedules match, then the trade is approved, and the schedules traded.

### BACKGROUND OF THE INVENTION

1. Technical Field

The invention relates generally to employee scheduling and, more particularly, to enable employees to trade scheduled shifts.

2. Description of the Related Art

Employees, assigned specific work schedules, often need to trade their schedules with other employees. This can be for a variety of reasons, such as for personal reasons or to fulfill family obligations.

A trade means that the employee is offering a specific set of one or more scheduled shifts in exchange for a set of desired shifts. Traditionally, for a trade to occur between two employees, a first employee must try and locate a second employee who (a) has been scheduled to work the shifts that the first employee desires (b) is interested in trading those set of shifts, and (c) is interested in working the set of shifts that the first employee is scheduled to work. All three conditions must be met before two employees can take their trade to a supervisor for approval.

If specific skills, such as being bilingual, are required to work the shifts, a supervisor must then ensure that both the first employee and second employee have the necessary qualifications to work each other's shifts, prior to approving the trade.

Typically therefore, employee schedule trading is a tedious, manual, and often frustrating process for employees and for their supervisor. Therefore, there is a need for an improved method of trading employee schedules on-line.

### BRIEF SUMMARY OF THE INVENTION

It is an object of the invention to enable given entities (e.g., employees, agents, contractors, or others) to trade work schedules online, thereby reducing paperwork and administration.

It is a more specific object of the invention to allow such entities to trade schedules online, preferably according to rules defined by a supervisor.

It is yet another more specific object of the invention to provide a work schedule trading forum. To request a trade, an agent preferably posts his or her schedule to an online trade board and indicates what he or she would like in return for that schedule. Preferably, another agent is then able to accept the posted schedule, for example, if he or she has a schedule that matches the posting agent's request, and if all other supervisor-imposed constraints are otherwise met.

It is still another more specific object to provide for such a scheduling trading forum where trades may be approved automatically or by a supervisor, depending on supervisor-imposed rules or other policies. Once a given trade is approved, preferably the entity schedules are traded automatically.

A further object of the invention is to provide a computer-implemented method of work schedule trading. It enables a pair of entities, each of whom has a schedule that the other wants, to find each other and to conduct a trade easily and efficiently. The invention provides an online trade board where entities can see what trades have been posted, or post their own trade requests, without having to search for another entity with whom to trade.

It is another object of the invention to enable entities to post any scheduled workday or time period for trading to a virtual “bulletin board.”

It is a further object of the invention to enable agents to view their work schedule trade history, including trades that are pending, completed, unsuccessful, or canceled. Agents preferably receive alerts, notifying them of their trade results.

It is still another object of the invention to enable entities that ability to view all or some posted schedules on the bulletin board, or only those schedules that “match” their schedules.

Yet another object of the invention is to provide a scheduling trading system that enables contact center agents can stay at their desk, ready to handle a next contact while looking for a posted trade, or posting a trade, instead of leaving their workspace to go to a bulletin board to look for a trade.

It is another object of the invention to implement a work scheduling trading function in a distributed computer networking environment that uses flexible work rules that are preferably established by a supervisor entity. Preferably, the rules are customized and govern various trading criteria. For example, to ensure adequate coverage, an administrator may set a trading rule that requires agents trading schedules to have the same skills. Additionally, a workplace manager can establish rules to disallow certain agents from trading schedules. Other trade rules that can be implemented include, for example: a minimum advance notice required, in hours, a maximum advance notice allowed, in days, a minimum amount of time that may be traded, in hours, a maximum amount of time that may be traded (per some given time period), a requirement that trade schedules must fall within a configurable number of weeks (or within the same week), a requirement that trade schedules must fall in the same calendar month or other user-defined pay period, a requirement that trades may not produce overtime for agents, a requirement that certain trades require supervisor approval or be approved automatically, a requirement that agents must be in the same agent group, a requirement that agents must have the same skills, a requirement that agents must belong to the same group (e.g., full-time agents might only be allowed to trade with other full-time agents), a permission that agents are allowed to give away time, a permission that agents are allowed to trade partial schedules, and the like.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram of an illustrative trading rules display according to an embodiment of the invention;

FIG. 2 is an illustrative trade board display rules display according to an embodiment of the invention;

FIG. 3 is an illustrative agent permissions display according to an embodiment of the invention;

FIG. 4 is an illustrative supervisor approval display according to an embodiment of the invention;

FIG. 5 is an illustrative agent “wants to trade” schedule display according to an embodiment of the invention;

FIG. 6 is an illustrative agent “wants in return” schedule display according to an embodiment of the invention;

FIG. 7 is an illustrative agent trade requests display according to the invention;

FIG. 8 is an illustrative trade board display according to an embodiment of the invention;

FIG. 9 is an illustrative trade details display according to an embodiment of the invention;

FIG. 10 is an illustrative confirm trades display according to an embodiment of the invention;

FIG. 11 is a block diagram of a computer system in which the present invention may be implemented; and

FIG. 12 is a flowchart showing a functional overview of an illustrative embodiment of the present invention;

### DETAILED DESCRIPTION OF AN EMBODIMENT

In the following discussion, the invention is described in the context of a contact center environment, although it should be understood that the invention can be practiced in other types of environments such as, without limitation, sales force environments, field service environments, manufacturing environments, and other types of environments wherein entities (agents, employees, contractors, other persons, etc.) work according to assigned schedules. In a contact center, the environment generally comprises an automatic call distributer (ACD) and a multimedia server coupled to a host computer via a computer network. The ACD and multimedia server generally provide routing capabilities for incoming voice calls (via the ACD) and other contacts (via the multimedia server), such as faxes, email, voice mail, web requests, we call-back requests, web chats, web voice calls, web video calls, and the like. For ease of discussion, the persons who work at the contact center are referred to herein variously as “agents” or “employees.” These designations are used interchangeably within the following description. Of course, this nomenclature is not meant to be taken to limit the invention in any way, as the word “employee” or the word “agent” is meant to be broadly construed to include any person regardless of a particular legal status. An entity need not actually handle contacts, of course. A “schedule” is any ordered list of times at which given events or activities are planned to occur. Of course, as noted above, the present invention may be implemented in any work environment where entities desire to trade work or other task schedules.

As seen in FIG. 12, a distributed computing environment in which the schedule trading method and system of the invention may be implemented includes a set of computing-related entities (systems, machines, processes, programs, libraries, functions, or the like) that facilitate or provide an agent-supervisor network. In a typical implementation, the environment typically comprises a set of computers. A representative machine is a client workstation or a network-based server running commodity (e.g. Pentium-class) hardware, an operating system (e.g., Linux, Windows 2000, OS-X, or the like), an application runtime environment (e.g., Java), and a set of applications or processes (e.g., Java applets or servlets, linkable libraries, native code, or the like, depending on platform) that provide the functionality of a given system or subsystem. A client machine typically includes a Web browser (Internet Explorer, Netscape Navigator, Apple Safari, or the like) or other rendering engine. A Web browser typically includes or supports media players and other plug-ins. The present invention implements a distributed platform that enables employees to trade schedules over a network including, without limitation, the publicly-routable Internet, a corporate intranet, a private network, or any combination thereof. The method may be implemented as a standalone product, or as a managed service offering. Moreover, the method may be implemented at a single site, or across a set of locations.

It is further noted that, unless indicated otherwise, all functions described herein may be performed in either hardware or software, or any combination thereof. In a preferred embodiment, the functions are performed by one or more processors executing given software.

In illustrative agent-supervisor network 1200, a central database 1202 is used to store data comprising a “trading board,” which will be illustrated in more detail below. The trading board may be accessed by an agent or a supervisor. As will be described, the trading board is accessed and modified by one or more machines, such as a supervisor machine 1204, entity A 1206, entity B 1208, entity C 1210 and entity D 1212. In this example, only four entities are shown, but in a typical implementation, there will be many more depending on the number of entities at a specific location, or across a set of locations.

As noted above, the agent-supervisor network 1200 may be implemented in a number of ways, including client-server, distributed computing architecture and so on. Supervisor 1204 and entity A 1206, entity B 1208, entity C 1210, entity D 1212 typically access database 1202 using a Web browser or other user interface.

As will be seen, the supervisor 1204 may set up the trading board by defining trade rules, the rules as to how the trading board may be displayed, and by determining which entities are permitted to trade which type of schedules. Once the trade board is setup, one or more of the agents, in this example entity A 1206, entity B 1208, entity C 1210, entity D 1212, use various displays (as will be described) to post their own schedules on the trading board, to view the schedules of other entities, to select and trade schedules with other entities, and to view trades already made.

As will be seen, if supervisor 1204 has set the trade rules to automatically authorize trades, a trade may be completed without any supervisor involvement. If, however, the supervisor 1204 has set the trade rules to require manual authorization, the supervisor must review and approve (or deny) trades manually.

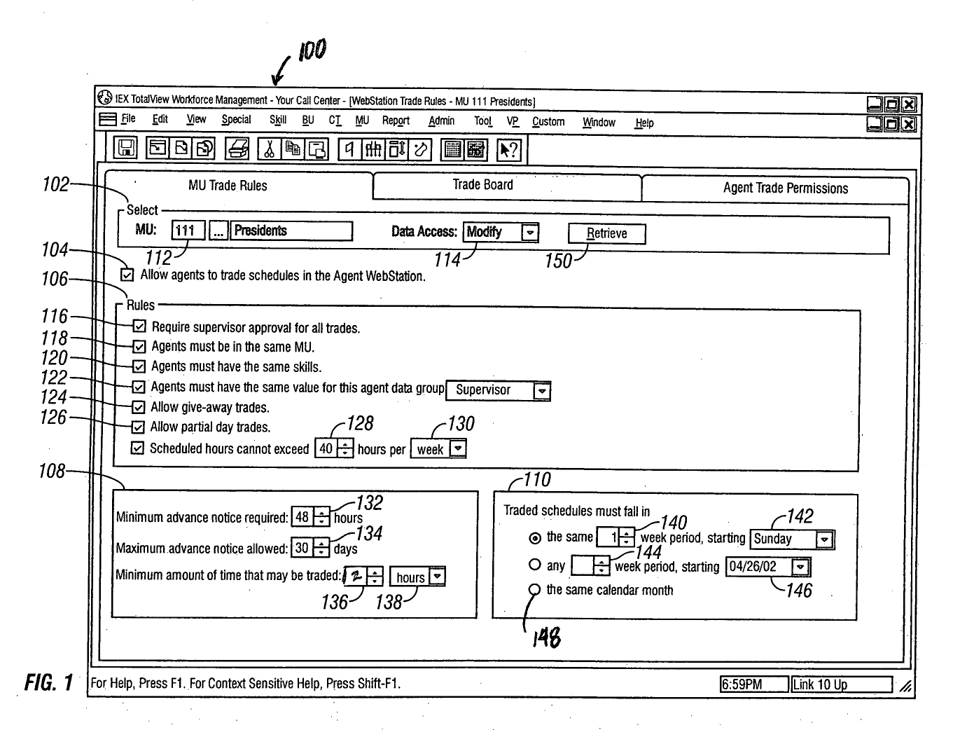

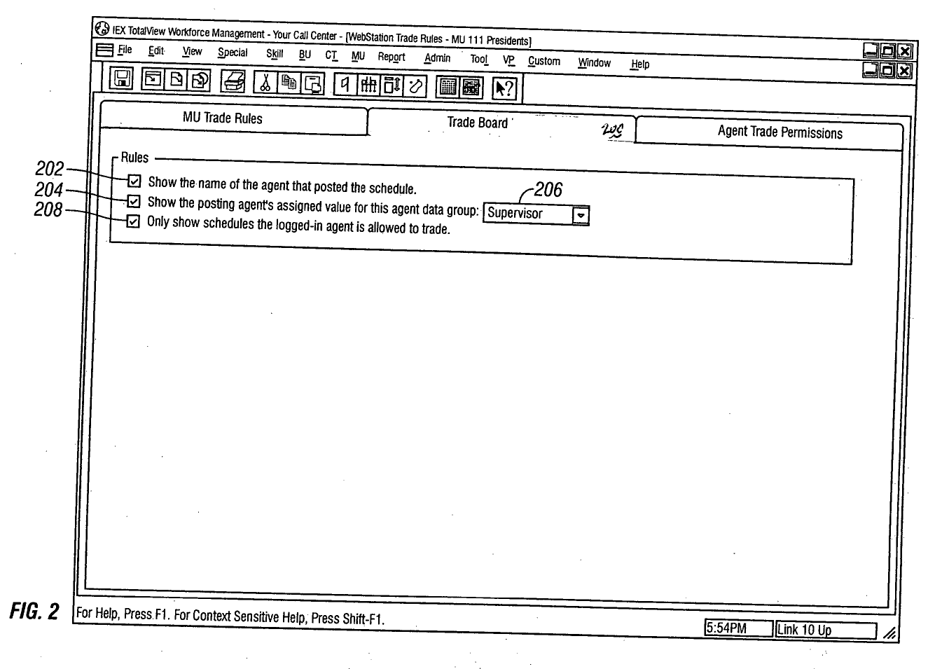

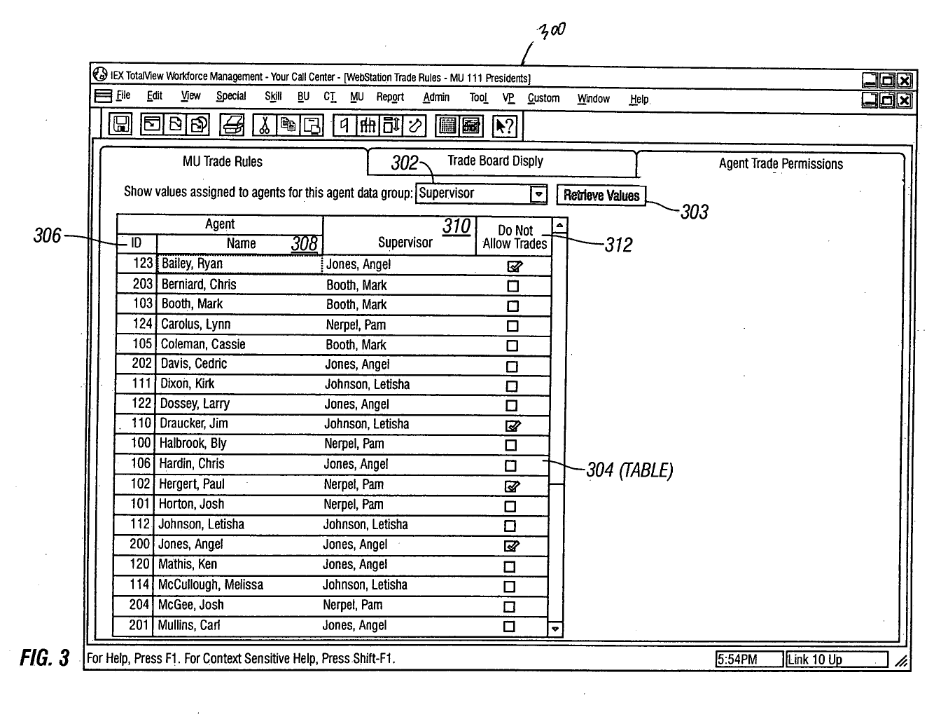

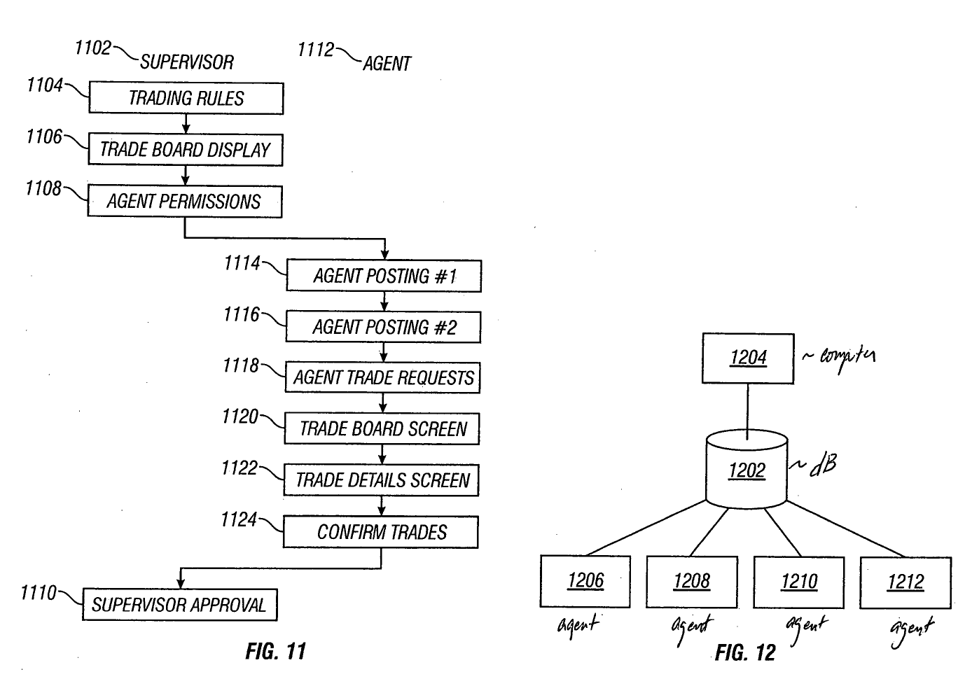

FIG. 11 illustrates the high level operation of the invention, with supervisor tasks shown on the left side of the flowchart and agent tasks shown on the right side of the flowchart. The particular operations (or any subset of them) need not be carried in the temporal sequence illustrated in FIG. 11. As illustrated, a supervisor 1102 first sets up the trading board by establishing trading rules in step 1104. The trading rules preferably are defined in a trading rules display (FIG. 1), and these rules preferably determine which trades are allowed and which trades are not allowed. At step 1106, supervisor 1102 preferably sets up a trade board display (FIG. 2) that may be used to define the way in which the trade board is displayed for agents. At step 1108, supervisor 1102 sets up an agent permissions display (FIG. 3) that may be used to define which agents are permitted to make trades. Of course, while only a single supervisor is described in connection with the steps of FIG. 11, this is not a limitation. Once supervisor 1102 has set up the trading board using trading rules, how the trade board should be displayed, and the agent permissions display, agents preferably start trading schedules.

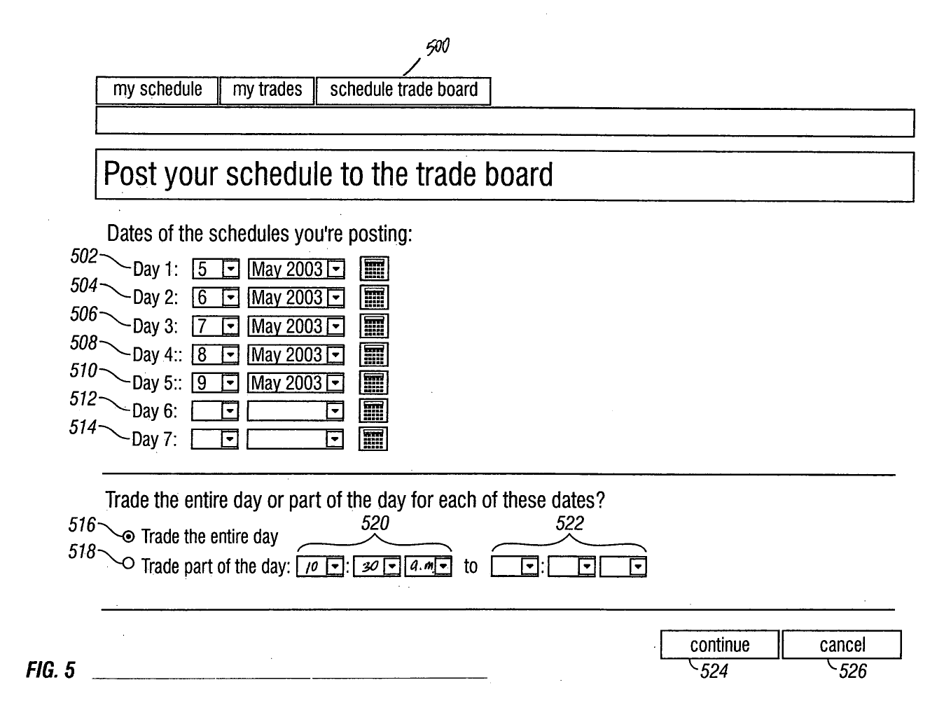

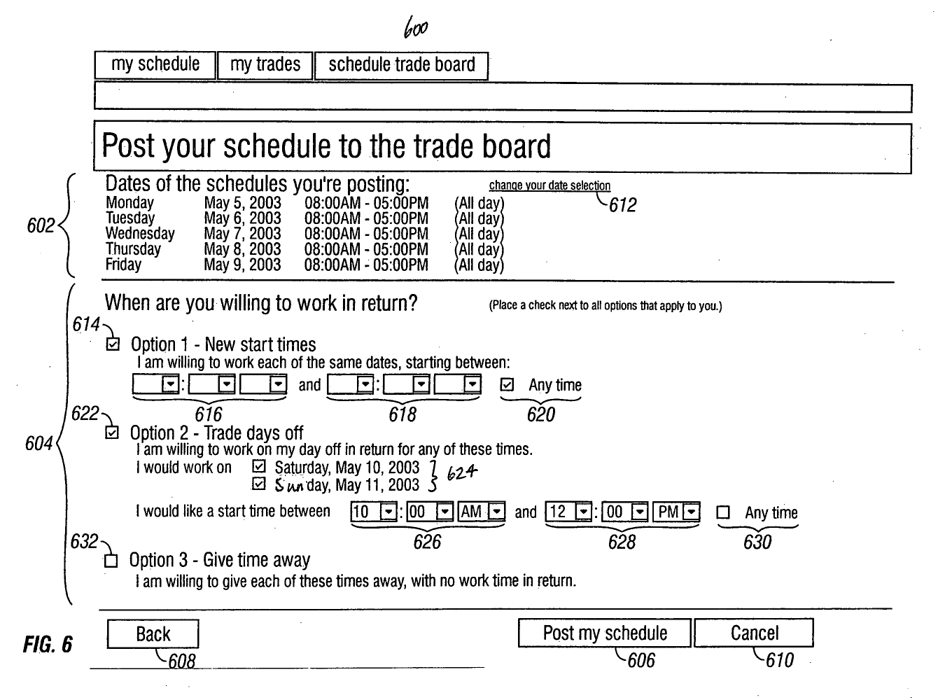

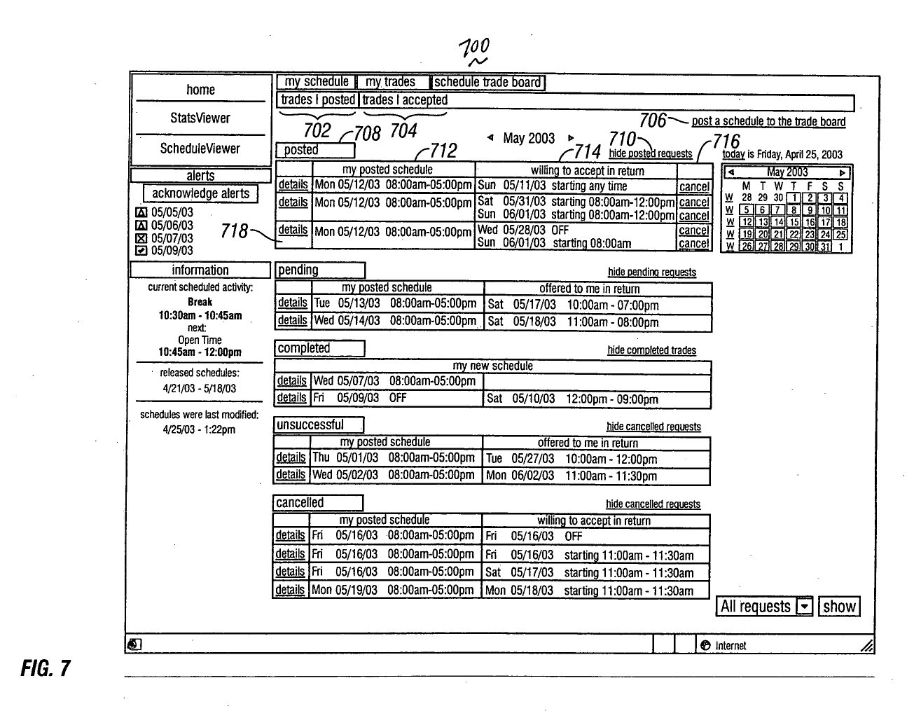

In an illustrative example, an agent 1112 selects which schedule(s) he or she wishes to post, preferably using a “wants to trade” display (FIG. 5). This is step 1114. The agent can then review and confirms the schedule(s) to be posted, preferably using a “wants-in-return” screen (FIG. 6) at step 1116. Agent 1112 can view the posted schedules, preferably using an agent trade requests display (FIG. 7), which is step 1118.

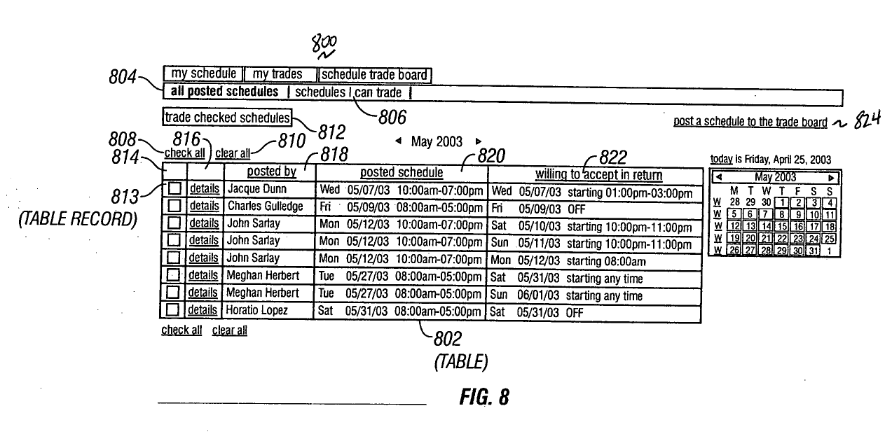

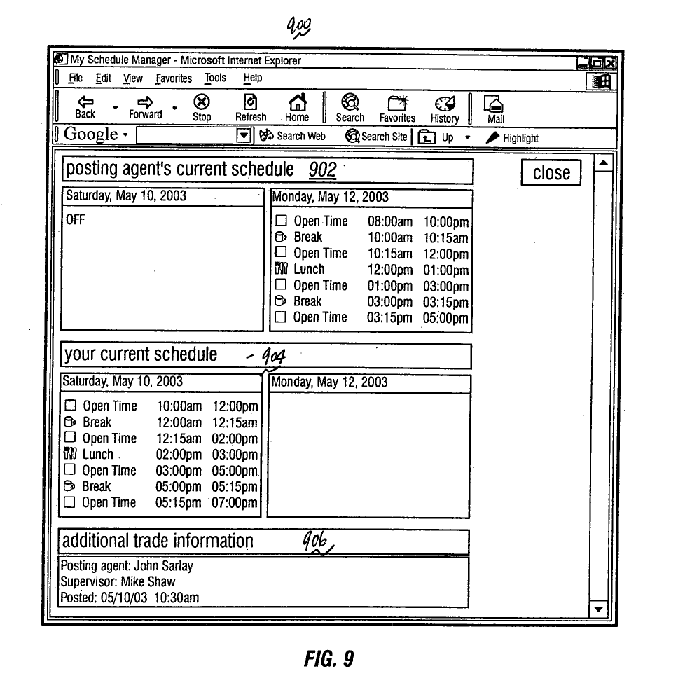

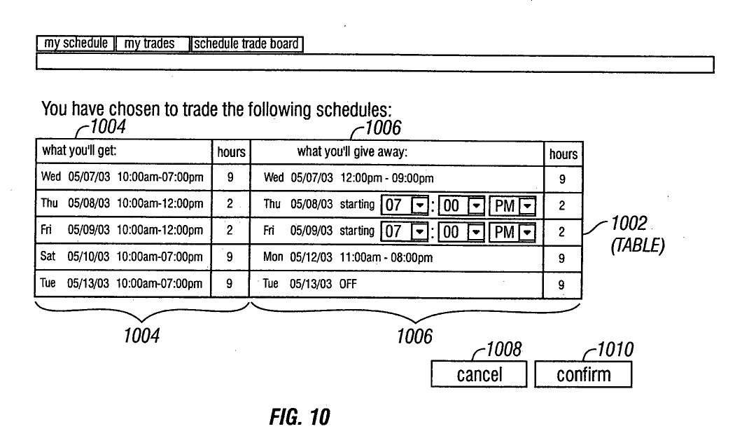

Agent 1112 may view the trading board and select schedules for trading, preferably using trade board display (FIG. 8). This is step 1120. Once agent 1112 has selected one or more schedules for trading, he or she can review the details of the offered and offered-in-exchange schedules, preferably using a trade details display (FIG. 9). This is step 1122. The agent can then confirm the trade, preferably using a confirm trades display (FIG. 10), which is step 1124.

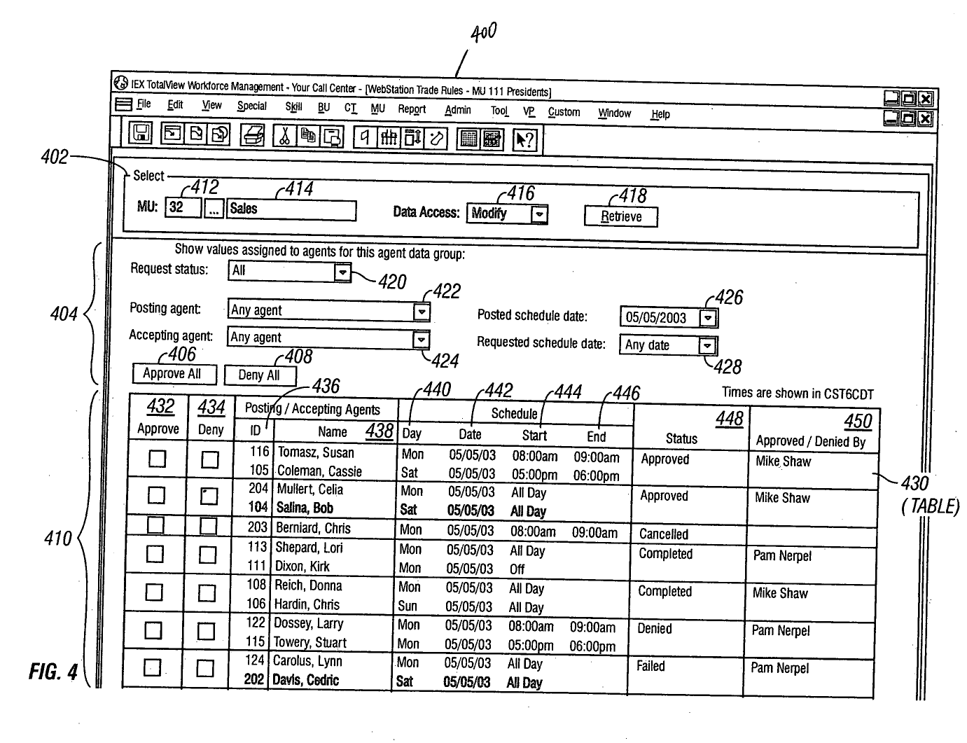

If supervisor 1102 has set up the trading rules to automatically approve trades that meet the defined rules, once agent 1112 has confirmed a trade, the trade is completed. If, however, the supervisor 1102 has set up the trading rules for manual approval, once an agent has confirmed a trade, the trade preferably has a pending approval status until supervisor 1102 approves it, preferably using a supervisor approval display (FIG. 4). This is step 1110 in FIG. 11.

FIGS. 1-10 illustrate various displays that may be used according to the present invention. The particular layout and format of a particular display is merely for illustrative purposes and is not meant to be taken to limit the scope of the present invention. Moreover, portions of given displays may be omitted or modified, or one or more of the various displays may be combined in any convenient manner without departing from the invention.

Referring to FIG. 1, the reference numeral 100 generally designates a trading rules display screen embodying an illustrative embodiment of the present invention.

Trading rules display 100 preferably includes a set of control tabs that are selectable to export views of various display screens. These tabs include a management unit (MU) Trade Rules tab (illustrated in FIG. 1), a Trade Board Display tab (illustrated in FIG. 2), and an Agent Trade Permissions tab (illustrated in FIG. 3). A “management unit” preferably is a set of one or more employees at a given level that are managed or manageable by a given entity (e.g., a supervisor) collectively. The present invention is not limited to employee trading in the context of management units, of course. One of ordinary skill in the art will also appreciate that other display navigation techniques may be used in lieu of or in addition to the display tabs shown in FIG. 1. Further, as used herein, a “supervisor” is any entity (a person, a machine, a program, or some combination thereof) that may exercise a control function over an entity (typically a person) that has a “schedule” associated therewith.

The MU Trade Rules display illustrated in FIG. 1 comprises various functions including a Select function 102 that enables the supervisor to select a given management unit (namely, a set of agents), an Allow function 104 that, if selected by the supervisor, enables agents to trade schedules online, a Rule-set function 106 that enables a supervisor to define various trading rules, a Minmax function 108 that enables the supervisor to define schedule trading notice requirements, and a Fall-in function 110 that enables the supervisor to define given time periods (for the assigned schedules) that may be traded. For payroll purposes, it may be desirable to force trades to occur within a given (e.g., 2 week) window. In this illustrative embodiment, the Select function 102 comprises a field 112 for identifying a particular MU and a Data Access field 114 that includes a drop down listbox with one or more functions such as Modify (shown), View, and the like. A Retrieve button 150 is used to retrieve previously stored data for a particular management unit. Rule-set function 106 comprises a number of checkboxes: approval 116, same-MU 118, same-skills 120, same-attribute 122, give-away 124, partial 126, hours 128, and per 130. The Minmax function 108 comprises one or more fillable fields such as: min-notice 132, max-notice 134, mintime 136 and minunits 138. The Fall-in function 110 comprises several fillable fields such as: week 140, starting-day 142, week-period 144, starting-week 146, and month 148. These fields and the various field descriptors, of course, are merely illustrative.

As one of ordinary skill in the art will appreciate, the trading rules display 100 is the screen a supervisor uses to define one or more trading rules by which employees may trade their assigned schedules. Using the select function 102, the supervisor first enters the management unit (MU) in fill-in field 112 either as a numeric value or as a name, and then he or she enters the type of data access, which can have the value modify or view; the supervisor then selects a Retrieve button 150 to retrieve the rules for the MU specified in MU 112. In an illustrative embodiment, a supervisor may only modify an MU for which the supervisor has permission to modify. Typically the supervisor will retrieve the rules for the purpose of modifying them, so the remaining discussion for FIG. 1 will focus on modifying the rules.

The Allow function 104 determines whether or not employees are allowed to trade schedules online. The Rule-set 106 comprises a plurality of rules with corresponding checkboxes. If the checkbox of a rule is checked the rule is used, and if it is not checked the rule is not used. Preferably, for a given trade to occur, the trade must satisfy the conditions of all the rules that are checked. For example, if rule 1 and rule 2 are checked, then a trade can occur only when rule 1 is satisfied and rule 2 is satisfied.

The Approval function 116 determines whether or not supervisor approval is required for all trades. If approval 116 is checked, the supervisor must approve all trades, and if it is not checked, trades are approved automatically if they satisfy the rest of the rules.

The same-MU function 118 determines whether or not agents must be in the same MU to trade schedules. Skills 120 determines whether or not agents must have the same skills to trade schedules. Skills are typically defined according to the requirements of the job(s) that agents are required to do. For example, in a contact center, agents may need to have bilingual skills, English and Spanish, so “bilingual” might be one of the skills required.

The Attribute function 122 preferably is a pull down menu with one or more user-defined attributes such as supervisor, skill group, etc. When attribute 122 is checked, this user-defined attribute must match for both entities wishing to trade schedules.

The Give-away function 124 determines whether entities can give away a shift, i.e., trade a schedule for nothing in return. The Partial checkbox 126 determines whether or not partial trades are allowed, i.e.,, whether part of a schedule may be exchanged.

The Per fill-in field and/or associated listbox 130 can have the value day or week, and when combined with the hours fill-in field and/or associated listbox 128, it can be used to set a maximum number of hours in a day or week that an entity can work if the trade is completed. The same constraints can be imposed to guarantee minimum values. Thus, for example, if the trade exceeds a maximum that is set using hours 128 and per 130, then the trade is not allowed. This is typically done if the supervisor wants to limit the amount of overtime that an entity will work after the trade is completed.

The Min-notice fill-in field and/or associated listbox 132 determines a minimum advance notice, preferably expressed in number of hours (or any other convenient units), required for a trade. Similarly, a max-notice fill-in field and/or associated listbox 134 determines a maximum advance notice, preferably expressed in number of days (or any other convenient units), required for a trade. The Mintime 136 and Minunits 138 fill-in fields and/or associated listboxes are used to set a minimum of amount of time that can be traded. Minunits 138 preferably is a pull-down menu that can have the values such as minutes, hours or days.

The Fall-in function 110 allows the supervisor several different ways of specifying which time period schedules must fall into for the trade to be allowed. A radio button preferably is selected or de-selected for this purpose. Thus, as illustrated, by selecting the first radio button the supervisor can specify that traded schedules must fall in a same time period, preferably specified by a week fill-in field 140, and he or she can also specify a start day of the time period, specified by a selection from a starting-day listbox 142. Alternately, by selecting a second radio button the time period can be defined as one or more weeks, specified by a week-period fill-in field 144, starting with a date, specified by selection from a starting-week listbox 146. Another alternative available to the supervisor is to check month radio button 148 and specify that schedules may only be traded if they both fall within a same calendar month (or in some other convenient time unit such as a payroll reporting period).

The Trade Board display tab (once it is selected) is illustrated in FIG. 2. Trading board display rules display 200 allows the supervisor to determine what information is displayed on the trade board. If Agent name checkbox 202 is selected, the name of the agent posting the schedule is displayed.

If Show attribute checkbox 204 and an attribute selection is made from listbox 206, an employee attribute is displayed on the trade board. Attribute 206 is a user-defined field that can be used by the supervisor to choose from a set of agent attributes in a pull-down menu. A supervisor may check the show attribute checkbox 204 to display a specific agent attribute, such as supervisor or skill.

If checkbox 208 is selected, the trade board only shows schedules that a logged-in agent is allowed to trade. This saves the agent time, as he or she can avoid searching through schedules for which he or she cannot trade. Of course, in certain circumstances, it may be desirable to allow an agent to see other agent schedules whether or not he or she can trade for those schedules.

FIG. 3 illustrates a representative display when the Agent Trade Permissions tab (from FIG. 1) is selected. In agent permissions screen 300, the supervisor can determine which particular agents are permitted to trade schedules.

Agent data group, field 302, is the same user-defined pull-down menu previously discussed in conjunction with attribute 206 and attribute 131 of FIG. 1. The user can use whatever attribute is selected in field 302 to display a table of all agents having the specified attribute by selecting from pull-down menu attribute 302 and then selecting the Retrieve Values button 303. An illustrative table is then displayed as shown.

Agent table 304 is merely representative. It displays an agent id 306, an agent name 308, an attribute field 310, and a checkbox 312 for selecting whether trades should be allowed or not allowed for each agent. Note that attribute field 310 contains the value, such as supervisor name or skill, specified in attribute 302. If the checkbox 312 is checked for a particular agent, that employee is not allowed to trade schedules. Of course, the display column may state the control function in the affirmative (namely, that trades are allowed), in which case selection of the checkbox would indicate that the employee is allowed to trade schedules. As illustrated in FIG. 3, the table includes a scrollbar to enable the user to move through the table rapidly. Alternatively, control can be expressed on the basis of a group of agents.

Now referring to FIG. 4, the reference numeral 400 generally designates a block diagram of a preferred form of supervisor approval screen. If the supervisor wishes to manually approve pending trades, e.g., trades that meet the rules specified in trading rules screen 100, then the supervisor can display and approve or deny pending trades in supervisor approval screen 400.

Supervisor approval screen 400 comprises an Select function 402, one or more filters 404, an approve-all control button 406, a deny-all control button 408 and a pending-trades table 410. Each of these will now be described.

The Select function 402 allows the supervisor to retrieve and either view or modify pending trades for a specific management unit (MU). This is done by entering or selecting an MU number in MU-number field 412, or by entering an MU name in an MU-name field 414, selecting a type of access, typically View or Modify, in a data access field 416, and then selecting a Retrieve button 418 to display the selected data. In this example, the data is illustrated in the table 410, which is described below

Filters 404 allows the retrieved data to be further filtered by specifying different criteria. Thus, for example, the Request status listbox 420 allows the retrieved information to be displayed based on the status of the requests. Status 420 can have one of several values: All, which preferably shows all possible requests; Posted, which preferably shows requests posted to the trading board but not yet accepted; Pending approval, which preferably shows requests that have been accepted and are awaiting supervisor approval; Approved, which preferably shows trades approved by the supervisor but that have not yet been performed; Completed, which preferably shows trades that were successfully completed; Denied, which preferably shows trades denied by the supervisor; Failed, which preferably shows trades that were approved but then failed for some reason, (e.g., such as the scheduled was changed in a way that made the trade invalid); or Cancelled, which preferably shows requests that were posted but then cancelled before any one accepted them. In the illustrated example, the Request status is All, and the Status field 448 shows several of these situations.

The retrieved data can also be filtered by selecting a given posting agent using the Posting agent dropdown listbox 422, by selecting a given accepting agent using the Accepting Agent dropdown listbox 424, by selecting a posted schedule date using a Posted Schedule date listbox 426, or by selecting a requested schedule date using a Requested schedule data listbox 428.

Preferably, the supervisor can approve or deny all displayed trades using an Approve All button 406 or a Deny All button 408, respectively.

Preferably, each entry 410 in the pending-trades table 430 displays information about the pending trades displayed. As illustrated, each trade (identified by the information in a particular row of the table) may be manually approved or denied by the supervisor using an Approve checkbox 432 or a Deny checkbox 434. Preferably, the agent id and agent name for both the offering and accepting agent are displayed in an agent ID column 436 and an agent Name column 438, respectively. Preferably, date and time information about the offered and accepted schedules are also displayed using Day column 440, Date column 442, Start time column 444, and End time column 446.

As described above, the Status column 448 displays the status of the request as filtered by the particular Request status 420, and thus displays whether the particular request is posted, pending approval, approved, completed, denied, failed, or cancelled. Preferably, the name of the supervisor who approved or denied the trade is displayed in supervisor column 450.

As one of ordinary skill will appreciate, FIGS. 1-4 describe representative supervisor screens for the inventive schedule trading method. Representative agent screens will now be described in detail.

Referring to FIG. 5, the reference numeral 500 generally designates a representative “wants-to-trade” display screen. An agent preferably posts schedules or partial schedules to the trading board using the display 500. In this illustrated example, the agent may specify the dates of up to seven days, e.g., using Day 1 field 502, Day 2 field 504, Day 3 field 506, Day 4 field 508, Day 5 field 510, Day 6 field 512 and Day 7 field 514 by selecting the day, month, and year for the schedule to be posted. Of course, any number of days may be used, and there is no requirement that sequential dates be entered. Of course, the month and year information can be separate.

Preferably, the agent can specify that an entire day is to be traded by selecting a full-day radio button 516, or he or she may specify that only a specified part of a day is to be traded by selecting a partial-day radio button 518 and then specifying a start time in start-time field 520 and the finish time in finish-time field 522. A drop down box is provided to set the hours, minutes, and the time of day designations.

If the agent is satisfied with the schedules selected for posting, he or she can select a continue button 524 to move to a next display screen. If the agent is not satisfied, the he or she can select a cancel button 526 to cancel the posting.

Now referring to FIG. 6, the reference numeral 600 generally designates the “wants-in-return” display, which is reached when the agent selects the “continue” button 524 in the first display.

A first portion 602 of the second display shows the schedules the agent has selected for posting on the trade board. A second portion of the second display 604 is where the agent specifies the schedules the agent wants in exchange for the agent's posted schedules. The second portion 604 thus facilitates the “wants-in-return” function because this portion of the display enables the agent to enter information identifying the schedules for which a trade may take place. This portion of the display is identified by the “When are you willing to work in return?” text, and the various functions of this display are described in more detail below.

The agent can post on the trading board by selecting a Post my schedule button 606, he or she may return to the previous screen (FIG. 5) and select different schedules to post by selecting a Back button 608, or he or she may cancel the posting by selecting a Cancel button 610.

As noted above, the first portion 602 of the second display shows the schedules selected by the agent in the first agent-posting display 500 of FIG. 5. If the agent wishes to change the date selection, he or she can select the change link 612.

In the second portion 604 of the display, the agent preferably can select one of three options. Using an option 1 checkbox 614, the agent can offer in exchange to work the same dates (in other words, one or more of the same dates as the agent has posted) but with different start times, in which case he or she can then specify that the start times be within a given range specified by a start-time fill-in field 616 and a start-time fill-in field 618. The agent may also indicate that any start time is acceptable by selecting a checkbox any-time 620.

By selecting an option 2 checkbox 622, the agent can specify that he or she is interested in working on one of his or her “off” days, in which case the agent can then specify which day(s) by selecting one or more of such days from a day-off list 624. Preferably, the day-off list 624 has associated checkboxes, and this list is populated with dates that are specific to the given agent. In this option, the agent preferably may also specify a start time using a start-time fill-in field 626 and a start-time fill-in field 628; alternatively, the particular agent may indicate that any start time is acceptable by selecting an any-time checkbox 630.

By selecting an option 3 checkbox 632, the agent indicates that the posted schedule is being given away and the agent therefore does not require anything in return.

Although not illustrated in detail, one of ordinary skill will appreciate that the first and second displays shown in FIGS. 5-6 may be combined.

FIG. 7 generally designates an agent trade requests screen that allows an agent to view his or her own trades using one or more different filters.

By selecting a posted-trades button 702, the screen displays the trades the agent has posted to the board. By selecting an accepted-trades button 704, the screen displays the trades the agent has accepted. Selecting a post-trades link 706 allows the agent to go to the screen shown in FIG. 5 to post a schedule to the trading board.

Each trade preferably is displayed using a similar format. In particular, preferably trades are grouped together based on their status, which as noted above in the illustrated example includes: posted, pending approval, approved, completed, unsuccessful, denied, failed, or cancelled. Trades may be displayed in any other convenient grouping or format, of course. I A Trade-status field 708 indicates the status of the trade request. A Hide similar requests link 710 allows the user to hide all currently displayed requests that have the same status as the record being displayed. Thus, if trade-status 708 is posted, then selection of link 710 will allow the user to hide all posted requests that are currently displayed.

For each type of trade-status, as noted above requests with the same status are preferably listed together. For each request, preferably one or more of the following information is displayed: the agent's posted schedule is shown in a posted-schedule column 712; what the agent is ready to accept in exchange is shown in an accept-in-return column 714; a cancel column 716, which allows the agent to cancel the trade; and a details link 718, which allows the agent to view details of the trade, and will be discussed in the trade details display.

Referring to FIG. 8, the reference numeral 800 generally designates trade board display screen that an agent uses to view and select one or more schedules for trading. This screen comprises a “virtual” bulletin board.

Schedule table 802 preferably displays all posted schedules if an all-posted button 804 is selected. Schedule table 802 displays all schedules the viewing agent can trade if a “schedules I can trade” button 806 is selected. The viewing agent can individually select schedules or use a check-all link 808 to select all displayed schedules, or he or she may use a clear-all button 810 to de-select all displayed schedules. Once an agent has selected one or more schedules to trade, the agent can trade those schedules by selecting a trade-schedules button 812, which is an action that preferably takes the agent to a confirm trades screen.

As also seen in FIG. 8, the table 802 preferably displays records based on the filters chosen. A record 813 in table 802 (which is a given row) preferably comprises a checkbox 814, a show-details link 816, a posted-by column 818, a posted schedule column 820, and a want-in-return column 822. Schedules can be individually selected for trade by selecting a given checkbox 814 in a given row of the schedule table 802. The Posted-by 818 column displays the name of the agent posting the schedule. The posted schedule column 820 and the want-in-return column 822 display the schedule the posting agent is offering and the schedule the posting agent wants in exchange, respectively.

An agent can post a schedule by selecting a post-schedule link 824. An agent can view the details of a posted schedule by selecting a show details link 816 in a given row of the table, which takes the agent to the trade details screen as will be seen.

Referring now to FIG. 9, the reference numeral 900 generally designates a trade details screen that allows an agent to view the details of a trade listed in the trade board screen.

Trade details screen 900 preferably comprises a “posting agent's current schedule” portion 902, a “your current schedule” portion 904, and an additional info portion 906. The portion 902 preferably shows the actual schedule of the agent posting a schedule in exchange, the portion 904 preferably shows the current, pre-trade, schedule (of the agent who desires to accept the trade), and the portion 906 shows information about the posting agent, such as his or her name, supervisor, and the date he or she made the posting.

As illustrated, the first portion 902 shows the days, dates and times of the posting agent's schedules for each day involved in the potential trade. The “your current schedule” portion 904 shows the days, dates and times of the schedules belonging to the agent viewing the schedules for each day involved in the trade. Of course, any other convenient way of arranging and displaying this data may be implemented.

Referring to FIG. 10, the reference numeral 1000 generally designates a confirm trades screen that allows an agent to view and confirm trades for schedules selected in the trade board display.

A Chosen-schedules table 1002 preferably displays a summary of the schedules selected in the trade board display 800 of FIG. 8. The first portion 1004 includes a “what-you'll-get” column that shows the day, date, start and end times, together with an “hours” column that identifies a number of hours for the schedule the viewing agent will get in exchange. A second portion 1006 includes a “what-you'll-give away” column that shows the day, date, start and end times, together with an “hours” column that identifies a number of hours for the schedule the viewing agent will give in exchange, as part of the trade. Of course, these titles and the various layouts and formats are merely illustrative.

After reviewing the schedules, the agent can select a cancel button 1008 to cancel and return to the trade board screen to select a different set of schedules. Alternately, the agent can select a confirm button 1010 to confirm the schedule trades.

In a particular embodiment, a particular agent operates a computer that is connectable to at least one server, with the server connectable to a computer network. In a preferred embodiment, the server provides a site or a set of pages (accessible, for example, via the public Internet, via an intranet, as an extranet application, or the like) within which given entities (e.g., agents) may post, view and negotiate to trade schedules. The server comprises at least one processor, a database of schedule information, and code executable on the server to enable entities to engage in schedule trading negotiation. As used herein, a “server” may refer to a given machine, or a set of machines or processes, whether centrally-located or distributed. The server also includes code for generating the supervisor displays (FIGS. 1-4) and for exporting views of those displays to client computers associated with those supervisors. Likewise, the server includes code for generating the agent displays (FIGS. 5-10) and for exporting views of those displays to client computers associated with the agents.

The present invention provides numerous advantages over the prior art. In the past, there has been no convenient way for employees to “trade” their schedules, or to enable supervisors to manage any such process in any meaningful way. The virtual bulletin board obviates the time consuming and manually intensive process in the prior art where an supervisor would post a calendar in some accessible locations and individual agents would be forced to enter schedules manually, or where individual employees would be forced to identify and track down potential scheduling trading partners. Of course, even in such manual techniques, there was no ability of the supervisor to easily manage (e.g., approve, deny, set up policies) for controlling how such trades (assuming they could be found) might be implemented. With the present invention, agents that are not handling contacts are freed to engage in scheduling searching and trading on the bulletin board without having to leave their desks.

The present invention provides a computer-implemented method of work schedule trading. It enables a pair of employees, each of whom has a schedule that the other wants, to find each other and to conduct a trade easily and efficiently. The invention provides an online trade board where employees can see what trades have been posted, or post their own trade requests, without having to search for another employee with whom to trade. In addition, the present invention ensures that supervisors need not be involved unnecessarily when employees want to trade work schedules. Because rules are defined that prevent employees from requesting invalid trades (or trades that the supervisor will not authorize), the supervisor need not be involved until a valid match is made (and, as noted above, such trades may even be approved automatically, i.e., without any direct supervisor involvement after the match is made).

The present invention allows an employee to indicate what schedule he or she would like in return for the schedule he or she is posting. For example, an employee may wish to work the same day, but just with a different start time; or, however, the employee may wish to work on one of his or her days off in return for the schedule he or she is giving away; or, the employee may not want anything in return, in which case he or she would end up working fewer hours during the particular period. Preferably, another employee would only be able to accept this trade if he or she has a schedule that the posting employee is willing to work.

Preferably, an employee can accept a schedule trade if he or she has a schedule that matches what the posting employee is looking for in return. This requirement need not be a limitation of the invention, however. In an alternative embodiment, the posting employee may be given the option of either specifying what he or she would like to work in return, accepting whatever the other employee has to give, or waiting until a particular trade request is accepted and, at that time, deciding whether or not he or she is willing to work the other employee's schedule. As another variant, the invention may enable an employee to post to the trade board information about the employee's days off, or information about an employee's other free time (e.g., such as lunch time or break time). In this variation, an employee may request a schedule to work in return for a day off. He or she might post to the board his or her lunch or break times, in return for different lunch or break times. Another variation is to enable employees to trade schedules that are of different lengths. In such case, unless an employee is giving his or her posted schedule away, the two schedules (or schedule segments) that are traded preferably are of equal length. A particular agent may use the system to trade with himself, such as when he or she wants to trade a day off.

The system may be set up to enable an agent to trade with a specific agent directly. In such case, a given agent may use the trading board to determine who has what schedule available and then request a trade with a specific agent having that schedule. In this embodiment, the requesting agent would initiate a request to the second agent, who desktop might then open up a popup window stating what the requesting agent is offering in return. Alternatively, the requesting agent may identify what he or she is looking for and cause the system to continually scan for that schedule. Once such a schedule is found, the requesting agent is notified, perhaps by email or other notification, that a possible trade is available. In this example, the requesting agent might then be provided with an option to accept or reject the schedule.

The present invention need not be limited to trading days off, of course. It may be used to enable employees to trade for special activities (such as slots in a training session), or the like.

Employees often have ancillary activities scheduled into their work day. Thus, a particular employee may have a special break time for whatever reason. If desired, the system may include the ability to include that special activity with the schedule being traded. Thus, the agent receiving the trade would then get the benefit of the special activity.

Although not meant to be limiting, generally the schedules being traded will have consistent time periods. Thus, for example, an 8.5 hour work schedule is traded for another 8.5 hour work schedule. This is not a limitation of the invention, however, as it may be desirable to enable variations or schedule trades involving unequal time periods but that are valued as equivalent according to some other metric.

One of ordinary skill will also appreciate that the invention can be implemented with supervisor approval required for a trade under certain conditions, but not others. Moreover, some of the above-described functions can be set on a per agent basis, as opposed to being set for an agent group.

As another variant, while the preferred embodiment has been illustrated in the context of having agents trade “days,” this-is not a requirement. The present invention may facilitate trades in any convenient time periods (less than or more than a given day).

Having described our invention, what we claim is as follows.

1. A method operative in a computer network for enabling entities to trade work schedules, comprising:
having a first entity post for display and trading a first work schedule, the first work schedule having associated therewith a second work schedule as defined by the first entity that the first entity is willing to accept in trade for the first work schedule; and
enabling a second entity to accept the first entity's first work schedule if a given condition is met.

2. The method as described in claim 1 wherein the given condition is that the second entity has a first work schedule that the first entity has indicated a willingness to accept in trade.

3. The method as described in claim 1 wherein the given condition is that the first and second entities are permitted to trade work schedules.

4. The method as described in claim 1 wherein the given condition is that a supervising entity has elected to approve a work schedule trade between the first and second entities.

5. The method as described in claim 1 wherein the given condition is that the first and second entities are members of a given workgroup.

6. The method as described in claim 1 wherein the given condition is that the first and second entities share a given skill.

7. The method as described in claim 1 wherein the given condition is that a given work schedule being traded does not exceed a given number of time units per a given time period.

8. The method as described in claim 1 wherein the given condition is that the given work schedule being traded satisfies a given time constraint.

9. The method as described in claim 1 wherein the given condition is that a notice requirement for permitting a schedule trade to occur has been respected.

10. Apparatus for use in conjunction with a database of agent work schedule information, comprising:
a processor;
code executable by the processor for generating a display from which a supervising entity manages how a set of agents can trade work schedules; and
code executable by the processor and responsive to a selection in the display for enabling enforcement of at least one rule selected from a set of rules that allow work schedules to be traded: (a) if first approved by the supervising entity, (b) if agents are members of a given workgroup, (c) if agents have a given skill attribute, (d) if a given work schedule being traded does not exceed a given number of time units per a given time period; (e) if a given work schedule being traded satisfies a given time constraint; or (f) if a notice requirement for permitting a schedule trade to occur has been respected.

11. Apparatus for use in conjunction with a database of agent work schedule information, comprising:
a processor; and
code executable by the processor for generating a display from which an agent entity may view work schedules available for trade, at least one of the work schedules posted on the display having associated therewith an alternative work schedule that a posting entity is willing to accept in trade for the work schedule.

12. The apparatus as described in claim 11 further including code executable by the processor and being responsive to a given selection for generating a display illustrating details of at least the work schedule or the associated work schedule.

13. The apparatus as described in claim 11 further including code executable by the processor and being responsive to a given selection for generating a display from which a given entity can confirm a set of one or more work schedule trades.

14. Apparatus for use in conjunction with a database of agent work schedule information, comprising:
a processor;
code executable by the processor for generating a first display from which a supervising entity can define at least one policy by which a set of agents can trade work schedules;
code executable by the processor for generating a second display from which the supervising entity can select whether a given identifiable agent is permitted to trade a work schedule; and
code executable by the processor for generating a third display from which the supervising entity can approve or deny a given work schedule trade.

15. A method operative in a computer network for enabling participating entities to trade work schedules, comprising:
having a first entity post for display and trading a first work schedule;
having a second entity notify the first entity that the second entity desires to exchange a second work schedule for the first work schedule; and
enabling the first and second entities to exchange online the first and second work schedules;
wherein one or more steps are performed using one or more processing devices.

16. The method as described in claim 15 further including the step of determining whether the first work schedule satisfies a given criteria established by the second entity.

17. The method as described in claim 16 further including the step of notifying the second entity that the first entity has posted the first work schedule for display and trading.
